(19) United States
(12) Patent Application Publication
(10) Pub. No.: US 2026/0172116 A1
(43) Pub. Date: Jun. 18, 2026

(54) TRANSPARENT OPTICAL REPEATER FOR SATELLITE, AND COMMUNICATION SATELLITE COMPRISING SUCH A REPEATER

(71) Applicant: THALES, Meudon (FR)

(72) Inventors: Mickael Faugeron, Toulouse (FR); Bernard Charrat, Toulouse (FR); Michel Alain Jean-Paul Sotom, Toulouse (FR); Anaëlle Maho, Toulouse (FR)

(21) Appl. No.: 19/422,089

(22) Filed: Dec. 16, 2025

(30) Foreign Application Priority Data
Dec. 17, 2024 (FR) 24 14329

(51) Int. Cl. H04B 10/293; H04B 10/118; H04J 14/06

(52) U.S. Cl. CPC H04B 10/293; H04B 10/118; H04J 14/06

(57) ABSTRACT

This transparent optical repeater, configured to be embedded onboard a satellite, includes a set of optical fibers, a first optical head, a low-noise optical amplifier, and a polarization separator and controller including a channel polarization separator and controller for each output channel of the band-pass filter. The repeater further include a third high-power optical amplifier per output channel of the polarization separator and controller, an orthogonal polarization combiner configured to recombine the two respective output channels of the two optical multiplexers, and a second optical head configured to transmit the output optical signals of the orthogonal polarization combiner.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This patent application claims the benefit of document FR 24/14329 filed on Dec. 17, 2024 which is hereby incorporated by reference.

### BACKGROUND

### Field

The present disclosure relates to the field of satellite telecommunications systems and, more particularly, to free-space optical links, acronym FSO for “Free Space Optical” in English, for massive data transfer, or “trunking” in English, between distant optical ground stations SSO1, SSO2, via a communication satellite SAT equipped with an optical repeater, as illustrated in FIG. 1.

### Description of the Related Technology

The present disclosure can also be implemented for optical stations that are not on the ground, such as for a link between an optical ground station, a satellite with a transparent repeater and an “optical station” on another satellite, or for a link between an “optical station” on a satellite, a satellite with a transparent repeater and an “optical station” on another satellite. A regenerative optical repeater as shown in FIG. 2 includes means of “optical/electrical” (O/E) detection and demodulation, very high-speed digital processing and “electrical/optical” (E/O) re-emission with laser sources and modulators, in addition to the classic optical elements of a terminal (amplifiers, demultiplexers, multiplexers etc.).

These fast digital processing means are combined in the form of a digital processor embedded onboard a satellite (OBP for “onboard processor”).

### SUMMARY OF CERTAIN INVENTIVE ASPECTS

An object of the disclosure is then to propose an optical repeater, configured to be embedded onboard a satellite, that enables making a free-space optical link, compatible with signals on one or two orthogonal polarization states, without compromising the mass, consumption and volume (MCV) budgets or the performance, that enables massive data transfer between two distant ground stations.

To this end, aspects of this disclosure relate to a transparent optical repeater configured to be embedded onboard a satellite, comprising: a set of optical fibers for transferring optical signals between the elements of the optical repeater; a first optical head, configured to collect optical signals, having two possible orthogonal polarizations, with an orthogonality defect of less than 10°, and to focus them; a low-noise optical amplifier, configured to amplify the optical signals transmitted at the output of the first optical head with added noise of less than 6 dB; a polarization separator and controller, arranged downstream of the low-noise optical amplifier, comprising a channel polarization separator and controller for each input channel, configured to separate the signals according to two possible orthogonal polarizations, to control the polarization of the signals and to deliver the separated polarization signals on two respective outputs; a third high-power optical amplifier, per output channel of the polarization separator and controller; a polarization combiner, arranged downstream of the polarization separator and controller, configured to recombine the signals from the two input channels; and a second optical head, configured to transmit the output optical signals of the orthogonal polarization combiner.

In one embodiment, the transparent optical repeater comprises: an optical demultiplexer, arranged between the low-noise optical amplifier and the polarization separator and controller, configured to separate the signals transmitted at the output of the low-noise optical amplifier by wavelength, and deliver the signals separated by wavelength on a plurality of output channels each corresponding to a wavelength; and an optical multiplexer, arranged between the third high-power optical amplifiers and the orthogonal polarization combiner, by set of output channels of the same polarization.

According to one embodiment, the transparent optical repeater comprises a second optical amplifier of a wavelength, per input channel of the polarization separator and controller.

In one embodiment, the transparent optical repeater comprises an optical band-pass filter, configured to filter the noise from the input channel(s) of the polarization separator and controller.

According to one embodiment, the transparent optical repeater comprises an optical switch, for each input channel of the polarization separator and controller, configured to be able to transfer the optical signals by another optical fiber to an external satellite processing device, and retransmit them after processing by the external satellite processing device to the polarization separator and controller.

In one embodiment, the external satellite processing device comprises an external processor.

According to one embodiment, a channel polarization separator and controller comprises: a polarization controller, configured to modify the polarization of the optical signals on command; a polarization separator, configured to separate the signals according to the two possible orthogonal polarizations on two respective channels; and one polarization tracking and control module per output channel of the channel polarization separator and controller, by polarization feedback loop.

According to one embodiment, a channel polarization separator and controller is configured to use low-frequency RF tone detection, a polarization tracking and control module comprising the polarization tracking and control module, and a module for minimizing one polarization or maximizing the other orthogonal polarization, the other polarization tracking and control module comprising the polarization tracking and control module, and a module for minimizing the other polarization or maximizing the polarization.

In one embodiment, a channel polarization separator and controller comprises a polarization tracking module configured to use optical power detection, when the received signals have only one polarization, so as to maximize the power on the useful output channel and minimize the power on the other output channel.

According to one embodiment, a channel polarization separator and controller comprises a polarization tracking module configured to detect part of the optical flow of a single polarization channel using a coherent receiver, and a digital processor configured to quantify the ratio of the two polarizations and to provide feedback on the polarization controller, to have only one polarization in the polarization channel comprising the tracking module.

In one embodiment, a channel polarization separator and controller comprises a polarization tracking module configured to use interference detection of the signals from the two polarization channels.

According to one embodiment, the interference detection of the signals from the two polarization channels is a Hansch Couillaud detection.

In one embodiment, the interference detection of the signals from the two polarization channels is a heterodyne detection.

According to another aspect of the disclosure, a communication satellite comprising a transparent optical repeater, as previously described, is also proposed.

### BRIEF DESCRIPTION OF THE DRAWINGS

The disclosure will be better understood by studying some embodiments, described as non-limiting examples and illustrated in the appended drawings in which:

FIG. 1 schematically illustrates a massive data transfer between distant optical ground stations, via a communication satellite.

FIG. 2 schematically illustrates a regenerative optical repeater for a communication satellite.

FIG. 3 schematically illustrates a transparent optical repeater for a communication satellite.

FIG. 4a schematically illustrates a transparent optical repeater for a communication satellite, according to one aspect of the disclosure.

FIG. 4b schematically illustrates a transparent optical repeater for a communication satellite, according to various aspects of the invention.

FIG. 5 schematically illustrates a transparent optical repeater for a communication satellite of FIG. 4a, capable of operating in regenerative mode.

FIG. 6 schematically illustrates an embodiment of a channel polarization separator and controller, according to one aspect of the disclosure.

FIGS. 7 to 10 schematically illustrate embodiments of a channel polarization separator and controller of FIG. 6, according to aspects of the disclosure.

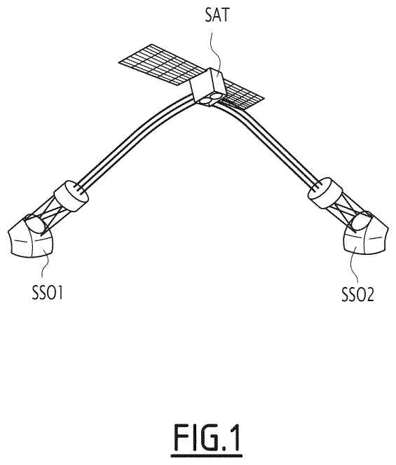

### DETAILED DESCRIPTION

A regenerative optical repeater presents a very high hardware complexity on board, with a significant impact on the mass, consumption and volume on board the satellite. In addition to feasibility and/or compatibility issues with the space environment of fast digital technologies, this represents a significant additional cost. Furthermore, this solution is dependent on the modulation format (waveform).

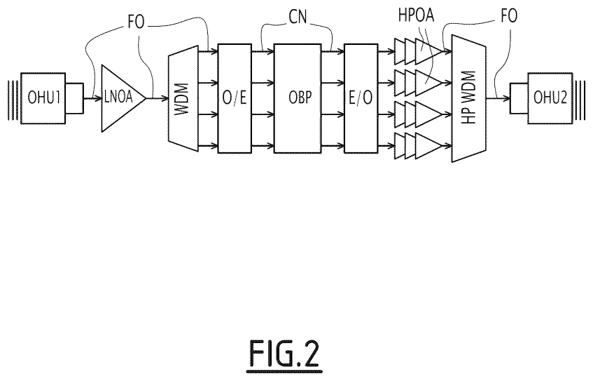

In the example of FIG. 2, the regenerative optical repeater comprises: a set of optical fibers FO, for transferring optical signals between the optical elements of the repeater, and digital connections CN, at the input and output of the digital processor OBP; a first optical head OHU1, configured to collect optical signals, having two possible orthogonal polarizations, with an orthogonality defect of less than 10°, and to focus them; a low-noise optical amplifier LNOA, configured to amplify the optical signals transmitted at the output of the first optical head OHU1 with added noise of less than 6 dB; an optical demultiplexer WDM, configured to separate the signals transmitted at the output of the low-noise optical amplifier LNOA by wavelength, and deliver the signals separated by wavelength on a plurality of output channels, each corresponding to a wavelength; an optical/electrical converter O/E, to convert the signals from the output channels of the optical demultiplexer WDM; the digital processor OBP, which demodulates the output signals of the optical/electrical converter O/E, performs digital processing, then modulates the output signals of the OBP; an electrical/optical converter E/O, to convert the signals from the output channels of the digital processor OBP; one high-power optical amplifier HPOA per output channel of the electrical/optical converter E/O; a high-power optical multiplexer HPWDM, to multiplex the output signals of the high-power optical amplifiers HPOA; and a second optical head OHU2, configured to transmit the output optical signals of the high-power optical multiplexer HPWDM.

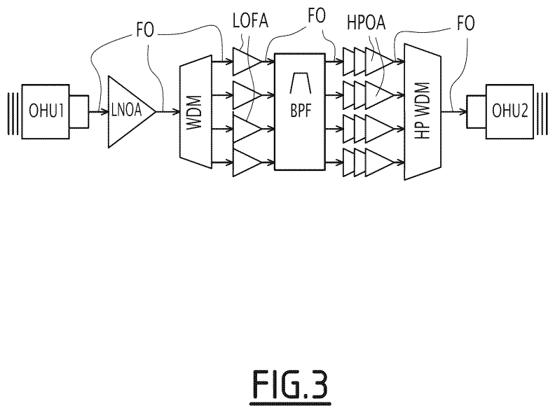

A transparent optical repeater is illustrated in FIG. 3, with polarization-independent HPOAs. This solution only includes classic optical means and elements (amplifiers, demultiplexers, filters, power amplifiers, multiplexers etc.), but no means of demodulation, nor very high-speed digital processing or E/O re-emission with laser sources and modulators. An all-optical repeater requires significantly higher power (typically +3dB), beyond the state of the art, so that the link budget for the targeted rates can be secured, and given that there is no regeneration of the signal quality on board.

In the example of FIG. 3, the transparent optical repeater comprises: a set of optical fibers FO, for transferring optical signals between the optical elements of the repeater; a first optical head OHU1, configured to collect optical signals, having two possible orthogonal polarizations, with an orthogonality defect of less than 10°, and to focus them; a low-noise optical amplifier LNOA, configured to amplify the optical signals transmitted at the output of the first optical head OHU1 with added noise of less than 6 dB; an optical demultiplexer WDM, configured to separate the signals transmitted at the output of the low-noise optical amplifier LNOA by wavelength, and deliver the signals separated by wavelength on a plurality of output channels, each corresponding to a wavelength; a second optical amplifier LOFA of a wavelength, per output channel of the optical demultiplexer WDM; an optical band-pass filter BPF, configured to filter the noise from the output channels of the second optical amplifiers LOFA; a third high-power optical amplifier HPOA, per output channel of the optical band-pass filter BPF; a high-power optical multiplexer HPWDM, to multiplex the signals from the third high-power optical amplifiers HPOA; and a second optical head OHU2, configured to transmit the output optical signals of the high-power optical multiplexer HPWDM.

However, the highest optical powers are typically obtained by polarization-dependent amplifiers, i.e. which only amplify one polarization state.

In order to close the link budget and/or to maximize the capacity (rate) of the link, it is advantageous to use polarization-dependent amplifiers.

Indeed, for a given fixed output power, about 3 dB in total power is gained if each polarization is amplified separately by a dedicated power amplifier.

Moreover, the use of polarization-dependent amplifiers may be necessary for reasons of performance (such as easier gain balancing) and/or of availability, for example.

A transparent optical repeater with upstream polarization maintenance includes maintaining the polarization state throughout the optical repeater embedded onboard the satellite.

In all the figures, identical references are similar.

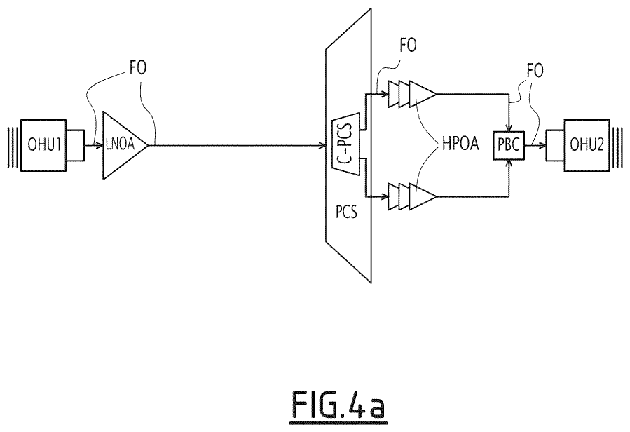

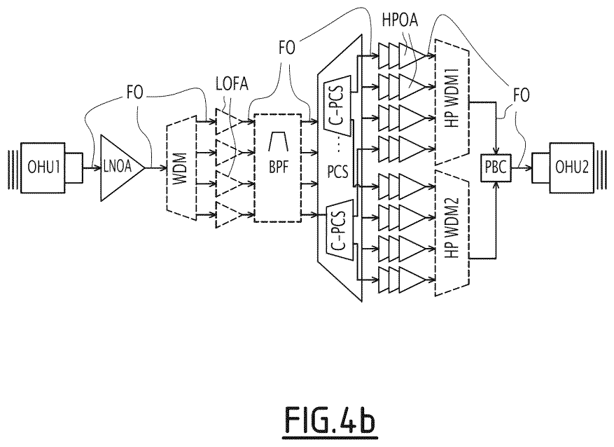

FIG. 4a schematically illustrates a transparent optical repeater for a communication satellite, according to one aspect of the disclosure.

The transparent optical repeater, configured to be embedded onboard a satellite, comprises: a set of optical fibers FO, for transferring optical signals between the elements of the optical repeater; a first optical head OHU1, configured to collect optical signals, having two possible orthogonal polarizations, with an orthogonality defect of less than 10°, and to focus them; a low-noise optical amplifier LNOA, configured to amplify the optical signals transmitted at the output of the first optical head OHU1 with added noise of less than 6 dB; a polarization separator and controller PCS, arranged downstream of the low-noise optical amplifier LNOA, comprising one channel polarization separator and controller C-PCS for each input channel, configured to separate the signals according to two possible orthogonal polarizations, to control the polarization of the signals and to deliver the separate polarization signals on two respective outputs; a third high-power optical amplifier HPOA, per output channel of the polarization separator and controller PCS; an orthogonal polarization combiner PBC, arranged downstream of the polarization separator and controller PCS, configured to recombine the signals from the two input channels; and a second optical head OHU2, configured to transmit the output optical signals of the orthogonal polarization combiner PBC.

The terms upstream and downstream are understood in relation to the signal transmission direction.

The present disclosure includes a succession of optical elements (amplifiers, demultiplexers, multiplexers, etc.) that maintain optical continuity throughout the telecommunications signal path.

It also includes active control devices and polarization separation by channel PCS in a more central stage, after the fibered input section, after channeling (i.e. optical demultiplexing).

The optical signals are processed in polarization, i.e. either separated into their two orthogonal components if they are dual polarized, or entirely projected onto one of the two orthogonal states if they are single polarized.

The output stage is made up by the third high-power optical amplifiers dependent on the polarization, which enable providing all available power to just one polarization state.

The different channels are then recombined by a high-power wavelength multiplexer HPWDM1, HPWDM2, by set of output channels of the same polarization. The orthogonal polarization channels are finally recombined by an orthogonal polarization combiner PBC. Advantageously, the orthogonal polarization combiner PBC is a device that is distinct from the polarization separator and controller PCS.

The insertion of this polarization separator and controller PCS enables each polarization to be amplified in the HPOAs dependent on the dedicated polarization, which typically enables a gain of 3 dB on the output power after recombination, and thus close the double bond link budget for a given rate, in better conditions, or increase the total rate.

Alternatively, this enables optimizing the capacity (rate) of the transfer link.

FIG. 4b schematically illustrates a transparent optical repeater for a communication satellite of FIG. 4a according to other aspects of the disclosure, further comprising optional elements, represented in dashed lines, which can be added alone or in combination with the elements of FIG. 4a.

The optional elements are:
a set comprising an optical demultiplexer WDM, arranged between the low-noise optical amplifier LNOA and the polarization separator and controller PCS, configured to separate the signals transmitted at the output of the low-noise optical amplifier LNOA by wavelength, and deliver the signals separated by wavelength on a plurality of output channels, with each corresponding to a wavelength; and an optical multiplexer HPWDM1, HPWDM2, arranged between the third high-power optical amplifiers HPOA) and the orthogonal polarization combiner PBC, by set of output channels of the same polarization;
a second optical amplifier LOFA of a wavelength, per input channel of the polarization separator and controller PCS;
an optical band-pass filter BPF configured to filter the noise from the input channel(s) of the polarization separator and controller PCS.

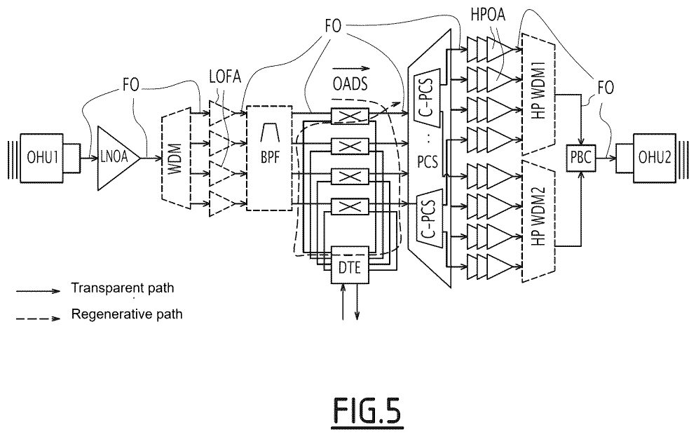

FIG. 5 schematically illustrates an embodiment of FIG. 4b, further comprising an optical switch OADS, for each output channel of the band-pass filter BPF, configured to be able to transfer the optical signals by another optical fiber to an external satellite processing device EPD, for “external processing device” in English, and to retransmit them after processing by the external satellite processing device EPD to the polarization separator and controller PCS.

The optical switches OADS enable routing the signal either directly to the polarization separator and controller PCS or to the external satellite processing device EPD.

For example, the external satellite processing device EPD can be a processor embedded onboard the communication satellite OBP acting as a regenerative repeater.

The optical switches OADS enable routing the optical signals for a transparent or regenerative operation of the payload, which enables this transparent optical repeater to operate in regenerative mode.

The path following the solid arrow represents the transparent case, while the path following the dashed arrow handles the regenerative case. In the transparent case, the signal passes from the band-pass filter BPF to the polarization separator and controller PCS.

In the regenerative mode operation, the uplink signal, or signal arriving through the first optical head OHU1, passes from the band-pass filter BPF to the external satellite processing device EPD, where the optical signal undergoes processing.

In the case of an OBP processor, the optical signal is demodulated. Once demodulated, the data from this signal can be used in the payload or re-sent as a new optical signal. This new downlink optical signal, or signal exiting through the second optical head OHU2, is at the same wavelength but carries either new data or the same data as the uplink signal. This signal exiting the OBP processor goes to the polarization separator and controller PCS via an optical switch OADS.

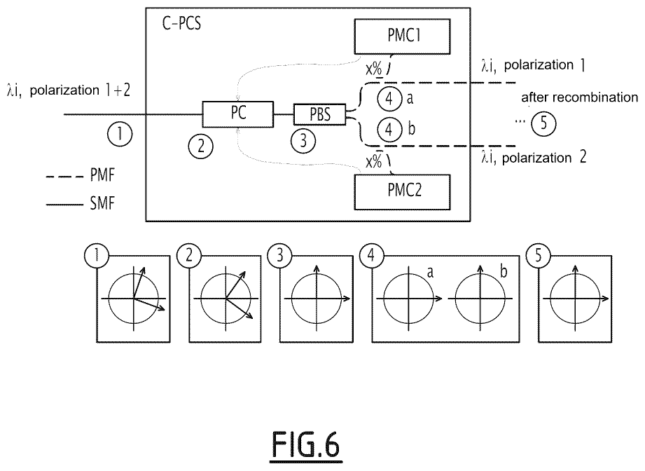

FIG. 6 schematically illustrates an embodiment of a channel polarization separator and controller C-PCS, according to one aspect of the disclosure.

SMF, acronym for “Single Mode Fiber” in English, represents single-mode optical fibers wherein the polarization evolves freely depending on the constraints on the fiber (temperature, mechanical constraint etc.).

PMF, acronym for “Polarization Maintaining Fiber” in English, represents single-mode optical fibers that maintain the polarization of light according to two orthogonal eigenaxes (slow axis and fast axis); if polarized light is injected according to one of these two eigenaxes, the polarization of the light is maintained during propagation.

The channel polarization separator and controller C-PCS comprises:
a polarization controller PC, configured to modify the polarization of the optical signals upon command;
a polarization beam splitter PBS, acronym for “Polarization Beam Splitter” in English, configured to separate the signals according to two possible orthogonal polarizations polarization1, polarization2 on two respective paths, projecting the components on the eigenaxes of the component's base. Each output signal contains one of the two components (inverse function of a PBC, acronym for “polarization beam combiner”).;
a polarization tracking and control module PMC1, PMC2, per output channel of the channel polarization separator and controller C-PCS. This concerns a polarization feedback loop
sampling and analysis of the light polarization,
calculation and generation of the control signal to be applied to the polarization controller PC according to the desired polarization value

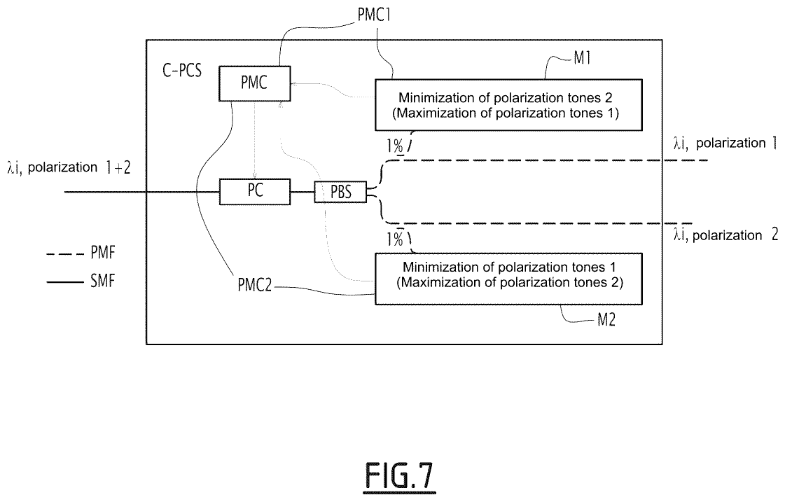

FIG. 7 schematically illustrates an embodiment of a channel polarization separator and controller C-PCS of FIG. 6 configured to use low-frequency RF tone detection. The polarization tracking and control module PMC1 comprises the polarization tracking and control module PMC, and a module M1 for minimizing the polarization, polarization2, or maximizing the polarization, polarization1. The polarization tracking and control module PMC2 comprises the polarization tracking and control module PMC, and a module M2 for minimizing the polarization, polarization1, or maximizing the polarization, polarization2.

Assuming there is an RF tone or one RF tone per polarization (for a dual-polarization signal, the tone fX is on the polarization polarization1 and the tone fY is on the polarization polarization2). By analyzing the tones of the output channel signal from the polarization polarization1, the polarization circulating in this channel can be deduced. The tone analysis can be done with a photodiode.

If the power of tones fX and fY is measured as being equal, the power distribution of each signal in the base of polarization states {polarization1; polarization2} can be deduced. If, on the other hand, the power of tones and fX is measured as being zero, it can be deduced that only the polarization polarization2 circulates in this output channel.

If having all the polarization polarization1 in the polarization output channel polarization1 is desired (and thus the polarization polarization2 in the polarization output channel polarization2, because the two polarizations are orthogonal), the polarization controller PC must be controlled in order to minimize the tone f2 in the polarization channel polarization1 (or minimize f1 in the polarization channel polarization2).

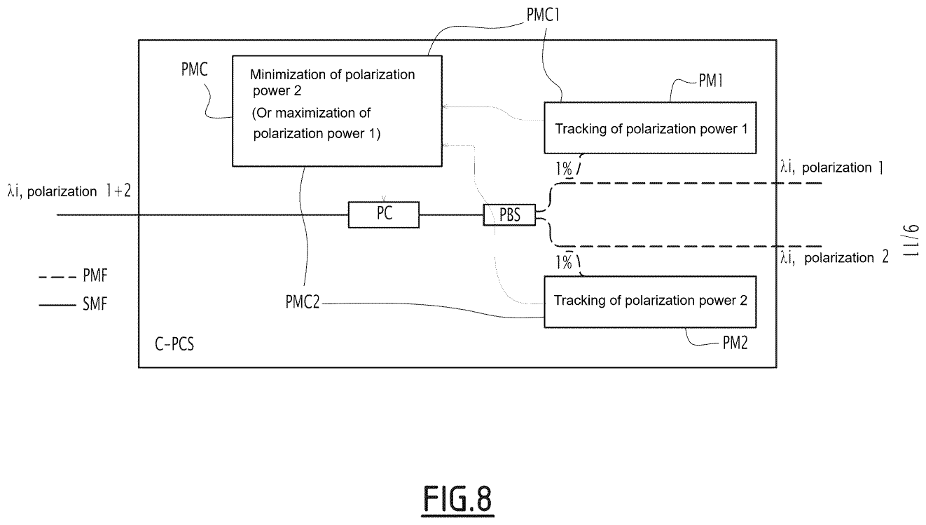

FIG. 8 schematically illustrates an embodiment of a channel polarization separator and controller C-PCS of FIG. 6, comprising a polarization tracking module PMC configured to use optical power detection when the received signals have only one polarization, so as to maximize the power on the useful output channel and minimize the power on the other output channel.

The polarization tracking and control module PMC1 comprises the polarization tracking and control module PMC configured to minimize the power of the polarization channel polarization1 (or maximize the polarization channel polarization2), and a power tracking module PM1 of the polarization channel polarization1. The polarization tracking and control module PMC2 comprises the polarization tracking and control module PMC, configured to minimize the power of the polarization channel polarization2 (or maximize the polarization channel polarization2), and a power tracking module PM2 of the polarization polarization2 channel.

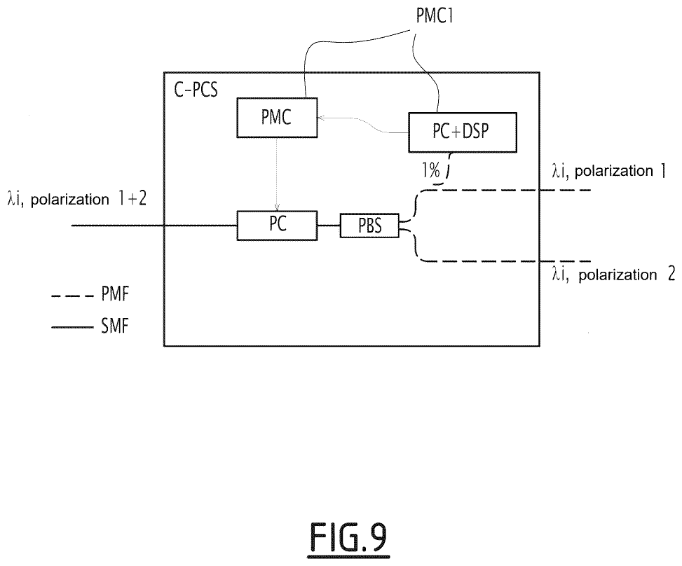

FIG. 9 schematically illustrates an embodiment of a channel polarization separator and controller C-PCS of FIG. 6, comprising a polarization tracking module PMC, configured to detect a part of the optical flow of a single polarization channel, in this case, the polarization channel polarization1 using a coherent receiver RC, and a digital processor DSP configured to quantify the ratio of the two polarizations polarization1, polarization2, and provide feedback on the polarization controller PMC, to have only one polarization in the polarization channel comprising the tracking module.

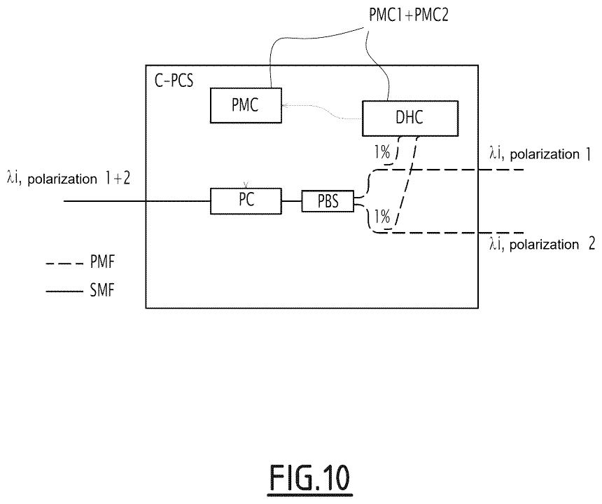

FIG. 10 schematically illustrates an embodiment of a channel polarization separator and controller C-PCS of FIG. 6, comprising a polarization tracking module PMC configured to use interference detection of the signals from the two polarization channels polarization1, polarization2, by a Hansch Couillaud detection DHC, for example.

As a variant of the Hansch Couillaud detection (DHC), a heterodyne detection can be used.

What is claimed is:

1. A transparent optical repeater configured to be embedded onboard a satellite, comprising:
a set of optical fibers for transferring optical signals between the elements of the optical repeater;
a first optical head configured to collect optical signals, having two possible orthogonal polarizations, with an orthogonality defect of less than 10°, and to focus them;
a low-noise optical amplifier configured to amplify the optical signals transmitted at the output of the first optical head with added noise of less than 6 dB;
a polarization separator and controller, arranged downstream of the low-noise optical amplifier, comprising a channel polarization separator and controller, for each input channel, configured to separate the signals according to two possible orthogonal polarizations, to control the polarization of the signals and to deliver the polarization separated signals on two respective outputs;
a third high-power optical amplifier, per output channel of the polarization separator and controller;
an orthogonal polarization combiner, arranged downstream of the polarization separator and controller, configured to recombine the signals from the two input channels; and
a second optical head configured to transmit the output optical signals of the orthogonal polarization combiner.

2. The transparent optical repeater according to claim 1, comprising:
an optical demultiplexer, arranged between the low-noise optical amplifier and the polarization separator and controller, configured to separate the signals transmitted at the output of the low-noise optical amplifier by wavelength and deliver the signals separated by wavelength on a plurality of output channels, each corresponding to a wavelength; and
one optical multiplexer, arranged between the third high-power optical amplifiers and the orthogonal polarization combiner, per set of output channels of the same polarization.

3. The transparent optical repeater according to claim 1, comprising a second optical amplifier of a wavelength, per input channel of the polarization separator and controller.

4. The transparent optical repeater according to claim 1, comprising an optical band-pass filter configured to filter the noise from the input channel(s) of the polarization separator and controller.

5. The transparent optical repeater according to claim 1, comprising an optical switch, for each input channel of the polarization separator and controller, configured to be able to transfer the optical signals by another optical fiber to an external satellite processing device and retransmit them after processing by the external satellite processing device to the polarization separator and controller.

6. The transparent optical repeater according to claim 5, wherein the external satellite processing device comprises an external processor.

7. The transparent optical repeater according to claim 1, wherein a channel polarization separator and controller comprises:
a polarization controller configured to modify the polarization of the optical signals upon command;
a polarization separator configured to separate the signals according to the two possible orthogonal polarizations on two respective channels; and
one polarization tracking and control module per output channel of the channel polarization separator and controller, by polarization feedback loop.

8. The transparent optical repeater according to claim 7, wherein a channel polarization separator and controller is configured to use low-frequency RF tone detection, a polarization tracking and control module comprising the polarization tracking and control module and a module for minimizing one polarization or maximizing the other orthogonal polarization, the other polarization tracking and control module comprising the polarization tracking and control module and a module for minimizing the other polarization or maximizing the polarization.

9. The transparent optical repeater according to claim 7, wherein a channel polarization separator and controller comprises a polarization tracking module configured to use optical power detection, when the received signals have only one polarization, to maximize the power on the useful output channel and minimize the power on the other output channel.

10. The transparent optical repeater according to claim 7, wherein a channel polarization separator and controller comprises a polarization tracking module configured to detect a part of the optical flow of a single polarization channel using a coherent receiver, and a digital processor configured to quantify the ratio of the two polarizations and provide feedback on the polarization controller to have only one polarization in the polarization channel comprising the tracking module.

11. The transparent optical repeater according to claim 7, wherein a channel polarization separator and controller comprises a polarization tracking module configured to use interference detection of the signals from the two polarization channels.

12. The transparent optical repeater according to claim 11, wherein the interference detection of the signals from the two polarization channels is a Hansch Couillaud detection.

13. The transparent optical repeater according to claim 11, wherein the interference detection of the signals from the two polarization channels is a heterodyne detection.

14. A communication satellite comprising a transparent optical repeater according to claim 1.
